(19) United States
(12) Patent Application Publication
(10) Pub. No.: US 2026/0329870 A1
(43) Pub. Date: Oct. 22, 2026

(54) SYSTEMS AND METHODS FOR GENERATING EVALUATED RESPONSES TO QUERIES USING MACHINE LEARNING

(71) Applicants: Constructor Technology AG, Schaffhausen (CH); Constructor Education and Research Genossenschaft, Schaffhausen (CH)

(72) Inventors: Alexander Tormasov, Bremen (DE); Serg Bell, Singapore (SG); Stanislav Protasov, Singapore (SG); Nikolay Dobrovolskiy, Alanya (TR); Laurent Dedenis, Geneve (CH)

(21) Appl. No.: 19/183,095

(22) Filed: Apr. 18, 2025

(51) Int. Cl. G06F 16/2457; G06F 16/338

(52) U.S. Cl. CPC G06F 16/24578; G06F 16/338

(57) ABSTRACT

In response to determining that an input query is not answered by a user responder within a threshold period of time: a system tags the input query as an input for a response generation ML model; generates a score representing a likelihood of the response generation ML model outputting a correct response to the input query based on characteristics of the input query and a knowledge base; executes the response generation ML model to answer the input query based on the score exceeding a threshold query evaluation score; and outputs the response for display on a computing device based on the score exceeding a threshold response evaluation score. In response to determining that the input query is answered by the user responder within the threshold period of time, the system executes the response generation ML model to generates and outputs a supplemental response based on a user response.

### FIELD OF TECHNOLOGY

The present disclosure relates to the field of machine learning, and, more specifically, to systems and methods for generating evaluated responses to queries using machine learning.

### BACKGROUND

Large language models (LLMs), such as those used in various artificial intelligence (AI) applications, are powerful tools capable of generating human-like text based on vast datasets. However, despite their impressive capabilities, these models can sometimes produce responses that contain inaccuracies. This is primarily due to several inherent limitations in their design and operation.

For example, LLMs rely on patterns in the data they were trained on, which may include outdated, biased, or incorrect information. LLMs lack true understanding and reasoning abilities, which may lead to plausible-sounding but incorrect or nonsensical outputs. Furthermore, the models do not have real-time access to current events or updates beyond their training cut-off, which can result in outdated information being presented as current. Users should be aware of these potential inaccuracies and verify critical information through reliable sources.

### SUMMARY

The present disclosure describes systems and methods for generating evaluated responses to queries using machine learning. In particular, a machine learning algorithm is used to evaluate input queries to determine whether a large language model (LLM) can generate a correct response to said input queries. After the LLM produces a response, a secondary machine learning algorithm evaluates the adequacy of the generated response. The two evaluation results may be used to determine whether the generated response needs to be modified by a person or whether the generated response may be directly presented for consumption.

In a particular use case, industry tutors often participate in the teaching process such as for short-term technical courses. However, they may be unable to support students at all times. The systems and methods of the present disclosure may be used to provide support to students when the tutor cannot. The system evaluates questions to determine the potential for generating a correct answer. A response to the question may then be either sent directly to the student or may be sent to the tutor for approval. If the system cannot generate an answer, the question is sent to the tutor.

In one exemplary aspect, the techniques described herein relate to a method for generating evaluated responses using machine learning (ML), the method including: in response to determining that an input query is not answered by a user responder within a threshold period of time: tagging the input query as an input for a response generation ML model; generating, for the input query to the response generation ML model, a score representing a likelihood of the response generation ML model outputting a correct response to the input query based on characteristics of the input query and a knowledge base including a plurality of documents and correspondence between the user responder and other user requesters; executing the response generation ML model to answer the input query based on the score exceeding a threshold query evaluation score; and outputting the response for display on a computing device based on the score exceeding a threshold response evaluation score; and in response to determining that the input query is answered by the user responder within the threshold period of time: executing the response generation ML model to generate a supplemental response based on a user response provided by the user responder and the input query; and outputting the supplemental response and the user response for display on the computing device.

In some aspects, the techniques described herein relate to a method, wherein the correct response includes an answer to the input query and/or clarifying questions pertaining to the input query.

In some aspects, the techniques described herein relate to a method, wherein the response is generated by the response generation ML model prior to determining that the input query is not answered by the user responder within the threshold period of time, and is outputted in response to determining that the input query is not answered by the user responder within the threshold period of time.

In some aspects, the techniques described herein relate to a method, wherein the score representing the likelihood of the response generation ML model outputting the correct response is generated by a query evaluation ML model in response to a score query.

In some aspects, the techniques described herein relate to a method, wherein the response generation ML model and the query evaluation ML model are each a large language model.

In some aspects, the techniques described herein relate to a method, wherein the characteristics of the input query include one or more of: an amount of detail and a relevance to the knowledge base of the response generation ML model, and wherein the characteristics of the response include one or more of: correctness, completeness, and contextual alignment.

In some aspects, the techniques described herein relate to a method, further including: transmitting the response to a different computing device of the user for verification ..

In some aspects, the techniques described herein relate to a method, wherein the input query is provided by a student and received via a user interface, and wherein the user responder is an instructor of the student.

In some aspects, the techniques described herein relate to a method, wherein the user interface is of a messaging application enabling communication between the student and the instructor.

In some aspects, the techniques described herein relate to a method, further including: receiving, from the different computing device, a modified version of the response as modified by the user responder; and outputting the modified version of the response for display on the computing device.

In some aspects, the techniques described herein relate to a method, wherein the score is a first score, further including: generating, for the response generated by the response generation ML model to the input query, a second score representing a likelihood of the response being correct based on characteristics of the response; and generating, by the response generation ML model, a new response to the input query based on the second score not exceeding the threshold response evaluation score.

In some aspects, the techniques described herein relate to a method, further including: transmitting an alert to a different computing device based on a threshold number of responses generated by the response generation ML model for the input query failing to have scores that exceed the threshold response evaluation score.

In some aspects, the techniques described herein relate to a method, further including: generating statistics based on all interactions between the user responder, the response generation ML model, and the other users.

In some aspects, the techniques described herein relate to a method, further including: prior to generating the new response, modifying the input query to improve the second score.

In some aspects, the techniques described herein relate to a method, further including: outputting, for display on the computing device, an indication that the response is generated using machine learning.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for generating evaluated responses to input queries using machine learning, including: at least one memory; and at least one hardware processor coupled with the at least one memory and configured, individually or in combination, to: in response to determining that an input query is not answered by a user responder within a threshold period of time: tag the input query as an input for a response generation ML model; generate, for the input query to the response generation ML model, a score representing a likelihood of the response generation ML model outputting a correct response to the input query based on characteristics of the input query and a knowledge base including a plurality of documents and correspondence between the user responder and other user requesters; execute the response generation ML model to answer the input query based on the score exceeding a threshold query evaluation score; and output the response for display on a computing device based on the score exceeding a threshold response evaluation score; and in response to determining that the input query is answered by the user responder within the threshold period of time: execute the response generation ML model to generate a supplemental response based on a user response provided by the user responder and the input query; and output the supplemental response and the user response for display on the computing device.

In some aspects, the techniques described herein relate to a non-transitory computer readable medium storing thereon computer executable instructions for generating evaluated responses to input queries using machine learning, including instructions for: in response to determining that an input query is not answered by a user responder within a threshold period of time: tagging the input query as an input for a response generation ML model; generating, for the input query to the response generation ML model, a score representing a likelihood of the response generation ML model outputting a correct response to the input query based on characteristics of the input query and a knowledge base including a plurality of documents and correspondence between the user responder and other user requesters; executing the response generation ML model to answer the input query based on the score exceeding a threshold query evaluation score; and outputting the response for display on a computing device based on the score exceeding a threshold response evaluation score; and in response to determining that the input query is answered by the user within the threshold period of time: executing the response generation ML model to generate a supplemental response based on a user response provided by the user responder and the input query; and outputting the supplemental response and the user response for display on the computing device.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating evaluated responses to input queries using machine learning.

FIG. 2 is a diagram illustrating a user interface with an evaluated response generated by a response generation model.

FIG. 3 is a diagram illustrating a user interface with an evaluated response generated by a response generation model and verified by a user.

FIG. 4 is a diagram illustrating a user interface with an evaluated response generated by a response generation model and modified by a user.

FIG. 5 is a diagram illustrating a user interface with a response written by a user due to a low evaluation score of the input query.

FIG. 6 illustrates a flow diagram of a method for generating evaluated responses to input queries using machine learning.

FIG. 7 presents an example of a general-purpose computer system on which aspects of the present disclosure can be implemented.

### DETAILED DESCRIPTION

Exemplary aspects are described herein in the context of a system, method, and computer program product for generating evaluated responses to input queries using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

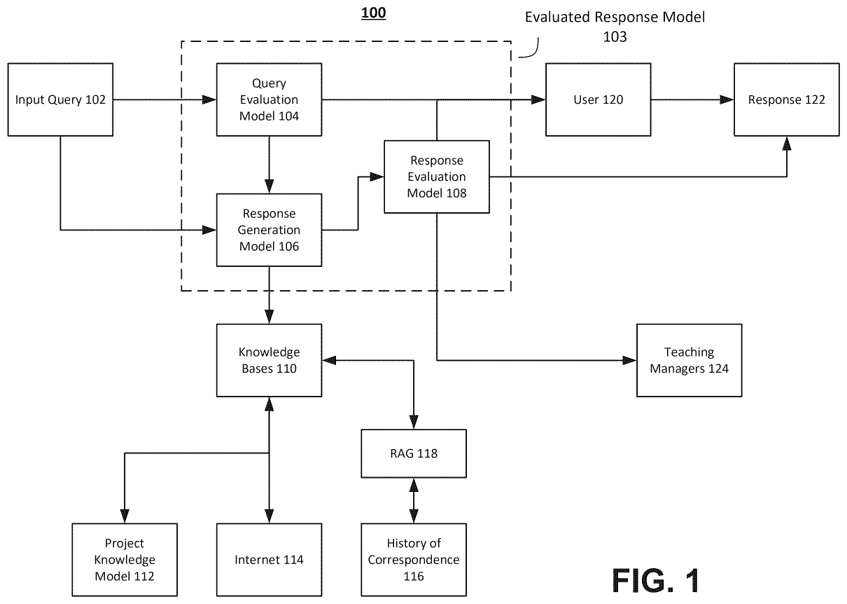

FIG. 1 is a block diagram illustrating system 100 for generating evaluated responses to input queries using machine learning. Input query 102 may include a question or statement provided via a user interface. Query evaluation model 104, which is a machine learning model (e.g., a large language model) may receive input query 102 and may calculate a score representing a likelihood (e.g., a probability) of response generation model 106 generating a correct response to input query 102. Query evaluation model 104 may evaluate input query based on, for example, the amount of detail in the query, whether response generation model 106 is trained to response to the details in the query, etc. In some aspects, query evaluation model 104 may trained using a training dataset that includes example queries and preassigned scores.

For example, a user might type “How do I implement a binary search algorithm in Python” or simply state “Binary search python” as input query 102. Query evaluation model 104 may assess this input by calculating a score that indicates the probability of response generation model 106 providing an accurate and relevant answer. This evaluation involves analyzing various factors, such as the specificity and complexity of the query. For example, a detailed query like “What are the time complexity and space complexity of a binary search algorithm, and how can it be optimized in Python?” may receive a higher score if response generation model 106 is specifically trained to handle such detailed inquiries. Conversely, a vague query might receive a lower score if the model lacks the necessary training to address it comprehensively. The evaluation process ensures that the system can effectively prioritize and respond to queries based on their content and the model's capabilities.

In some aspects, a score (e.g., 4/10) less than a threshold query evaluation score (e.g., 6/10) may trigger query evaluation model 104 to send input query 102 to user 120 (e.g., an expert such as a teacher or tutor) to respond to input query 102 manually. This is because response generation model 106 may be ineffective in producing a correct response and may be bypassed altogether to conserve computational resources. For example, response generation model 106 may be trained on data that is dated until June 2022. However, the query may ask about a programming method invented in 2024 (e.g., “explain how the 2024 binary search optimization method works in Python”). Because the response generation model 106 is not trained to understand the recent developments, query evaluation model 104 may output a low score.

In some aspects, when the score (e.g., 9/10) is greater than the threshold query evaluation score (e.g., 6/10), input query 102 is provided to response generation model 106, which may be a large language model that has access to or is trained on knowledge bases 110. In some aspects, if the score representing the likelihood of the response generation by the ML model outputting a correct response is above the threshold score, a response is generated by response generation module 106 and outputted on the user interface. In some aspects, determining the score is performed independently from determining whether a tutor has responded to the query.

Knowledge bases 110 serve as a comprehensive repository of information that enhances the capabilities of response generation systems. This repository includes several components: project knowledge model 112, the Internet 114, and a history of correspondence 116. Project knowledge model 112 is a specialized database containing domain-specific information, guidelines, and best practices relevant to particular projects or fields. This model ensures that responses are informed by the most pertinent and up-to-date project data. The Internet 114 component involves accessing a vast array of information from crawled web pages, providing a broad and diverse source of knowledge that can be leveraged to answer a wide range of queries. The history of correspondence 116 includes past interactions and communications (e.g., between students and teachers/tutors), allowing the system to learn from previous exchanges and improve its response accuracy and relevance over time. These components are made accessible through retrieval-augmented generation (RAG) 118, a sophisticated technique that combines retrieval of relevant information with generative models to produce more accurate and contextually appropriate responses. By integrating these diverse sources of knowledge, the system can deliver comprehensive and informed answers to user queries.

In an exemplary aspect, response evaluation model 108 is trained to evaluate the accuracy of response 122 generated by response generation model 106. Response evaluation model 108 also outputs a score that is compared against a threshold response evaluation score. The score from response evaluation model 108 represents a likelihood of the generated response 122 adequately answering input query 102. In some aspects, response evaluation model 108 is trained using a variety of data sets that include examples of both accurate and inaccurate responses, allowing it to learn patterns and criteria for evaluation.

Response evaluation model 108 operates by analyzing the generated response in relation to input query 102, considering factors such as the correctness, completeness, and contextual alignment of the response.

For example, in terms of correctness, response evaluation model 108 verifies whether the information provided in the response is factually accurate and aligns with established knowledge or data. For example, if the input query is “What is the time complexity of a binary search algorithm?” the response should correctly state “O(log n).” In terms of completeness, response evaluation model 108 verifies whether the response fully addresses all aspects of the input query. If a query asks, “What are the advantages and disadvantages of using Python for web development?” a complete response would cover both the benefits (such as ease of use and a large library ecosystem) and the drawbacks (such as performance issues compared to compiled languages).

In terms of contextual alignment, response evaluation model 108 verifies whether the response is relevant to the context provided by the query. This means understanding the nuances and specific requirements of the query. For instance, if the query is “How does Python handle memory management?” the response should focus on Python's garbage collection and memory allocation mechanisms, rather than general programming concepts.

This score is then compared against a threshold response evaluation score. If the score meets or exceeds the threshold, the response 122 is deemed satisfactory. For example, the response 122 may be output on the user interface where input query 102 is provided.

However, the score is less than the threshold response evaluation score, the response 122 may be flagged for review or further refinement. For example, the response may be sent to user 120, who may modify the response 122 or simply approve it for display on the user interface.

In some aspects, in response to a low score, response evaluation model 108 may command response generation model 106 to regenerate a response. In some aspects, response evaluation model 108 may modify input query 102 to improve the response that will be regenerated by response generation model 106. For instance, if input query 102 “Benefits of Python” results in a low-quality response, response evaluation model 108 may refine input query 102 to “What are the benefits of using Python for data analysis?” to elicit a more targeted and informative response. These strategies ensure that evaluated response model 103 (which includes models 104, 106, and 108) continuously improves its ability to deliver high-quality, relevant answers to user queries.

In some aspects, if after a threshold number of responses (e.g., 3) generated by response generation model 106 in response to input query 102 fails to elicit a score from response evaluation model 108 higher than threshold response evaluation score, response evaluation model 108 may transmit a warning to teaching managers 124. Teaching managers 124 may adjust knowledge bases 110 or retrain response generation model 106.

In some aspects, user 120 may adjust the threshold query evaluation score and/or the threshold response evaluation score. User 120 may further adjust whether all responses need approval. For example, in fully automatic mode, evaluated response model 103 sends all responses to a requesting user without approval from user 120. In semi-automatic mode, evaluated response model 103 sends all responses or at least those with a lower score (less than a threshold) for approval to user 120.

It should be noted that user 120 may be adjusted as well. In the context of education, sometimes projects have multiple mentors. Students or mentors can configure evaluated response model 103 to ask specific mentors or all of them, utilizing correspondence history with specific mentors or all mentors and obtaining their approval.

It should be noted that there are several advantages of using system 100 as compared to chatbots. Chatbots are automated conversational agents designed to simulate human interaction through text or voice communication. They are widely used across various industries to provide customer support, answer queries, and facilitate user engagement. In educational settings, chatbots can serve as virtual tutors, offering assistance to students by answering questions and providing guidance based on predefined data. Traditional tutor-support chatbots typically rely on fixed project documents, which means their responses are limited to the information contained within these documents. This approach restricts the chatbot's ability to offer personalized responses tailored to the unique needs and characteristics of individual students, as it does not incorporate the tutor's personal insights or teaching style.

In contrast, system 100 aims to enhance the personalization of chatbot responses by integrating the tutor's correspondence, including interactions related to other students and projects. By leveraging this broader range of communication, system 100 can provide responses that reflect the tutor's personality, expertise, and teaching methods. This approach allows system 100 to offer more nuanced and individualized support, as it can draw from the tutor's experiences and insights gained from various interactions. Consequently, students receive guidance that is more aligned with the tutor's unique approach, fostering a more engaging and effective learning experience. This innovative use of tutor correspondence ensures that system 100 can adapt to different learning contexts and provide support that is both relevant and personalized.

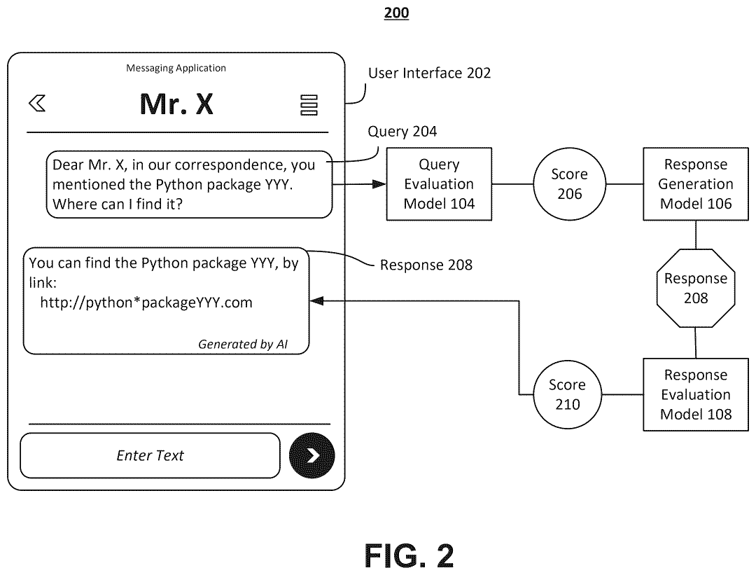

FIG. 2 is a diagram 200 illustrating user interface 202 with an evaluated response generated by a response generation model. For example, user interface 202 may be a messaging application with AI features. Suppose that Mr. X is a tutor of a student. The student may send a text to Mr. X via the message application. For example, input query 204 may state “Dear Mr. X, in our correspondence, you mentioned the Python package YYY. Where can I find it?”.

In some aspects, Mr. X may directly respond to the student using the messaging application. In an exemplary aspect, however, input query 204 is intercepted by query evaluation model 104, which generates score 206 (likelihood of the response generation model 106 generating the correct response). Suppose that score 206 is greater than a threshold query evaluation score. In response, response generation model 106 may generate response 208, which is evaluated by response evaluation model 108. Score 210 generated by response evaluation model 108 is compared against a threshold response evaluation score. If score 210 is greater than said threshold score, response 208 is outputted on user interface 202. For example, response 208 may state “You can find the Python package YYY, by link: http://python*packageYYY.com”. In some aspects, an indication that the text was generated using AI is added to the message for informational purposes.

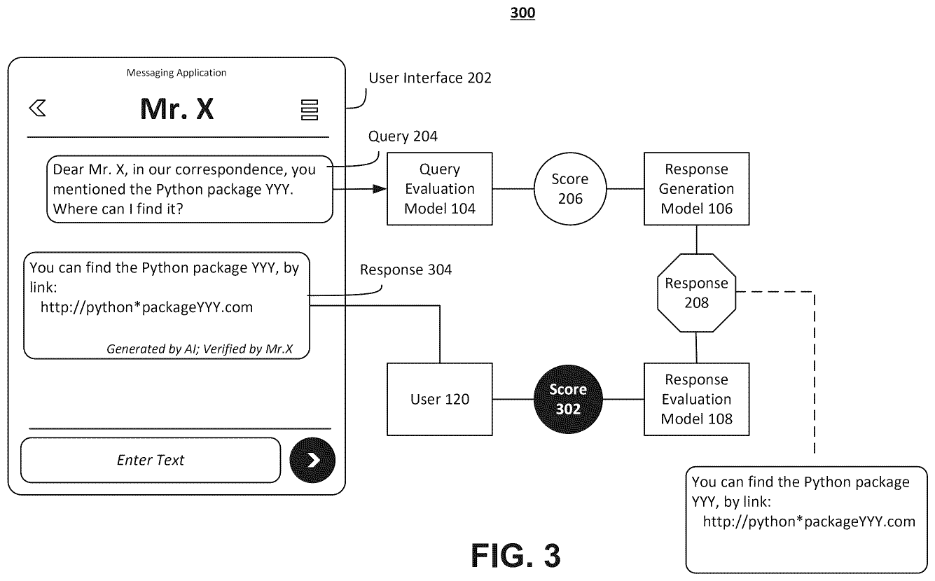

FIG. 3 is a diagram 300 illustrating a user interface with an evaluated response generated by a response generation model and verified by a user. Diagram 300 is similar to diagram 200, but suppose that response evaluation model 108 generates score 302 for response 208. Score 302 may be less than the threshold response evaluation score. Accordingly, response evaluation model 108 may transmit response 208 and score 302 to user 120. User 120 may be prompted (e.g., on user interface 202) to verify response 208. In diagram 300, user 120 may simply verify response 208 is correct. Accordingly, response 304, which adds that the response has been verified by Mr. X is displayed on user interface 202.

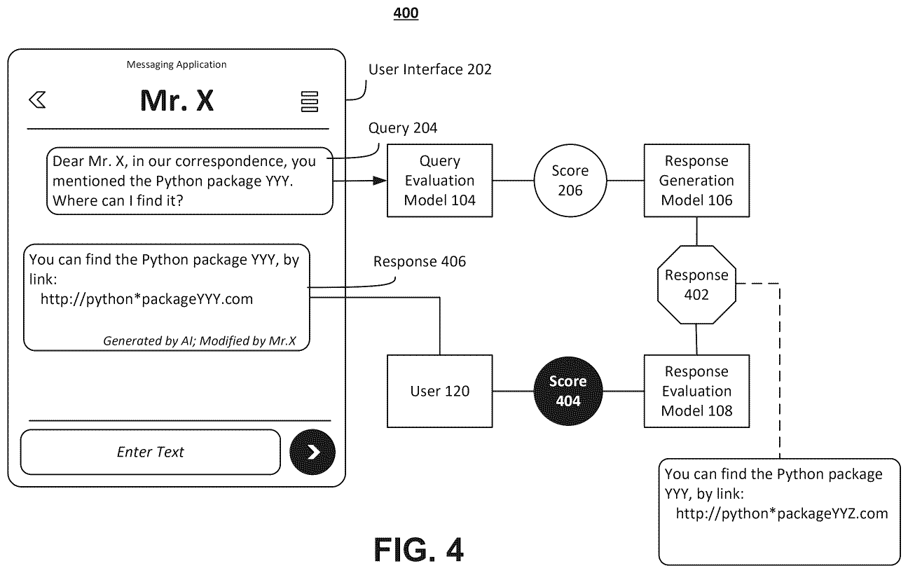

FIG. 4 is a diagram 400 illustrating a user interface with an evaluated response generated by a response generation model and modified by a user. In diagram 400, suppose that response generation model 106 outputs response 402, which has an error (e.g., an incorrect link). Response evaluation model 108 may generate score 404, which is less than the threshold response evaluation score. User 120 may thus be prompted to verify response 402. User 120 may then modify response 402 (e.g., correct the link). This modified response is output on user interface 202 as response 406. It should be noted that response 406 has an indicator stating that the response was originally generated by AI, but has been modified by Mr. X. In some aspects, the modification made may be displayed in redline.

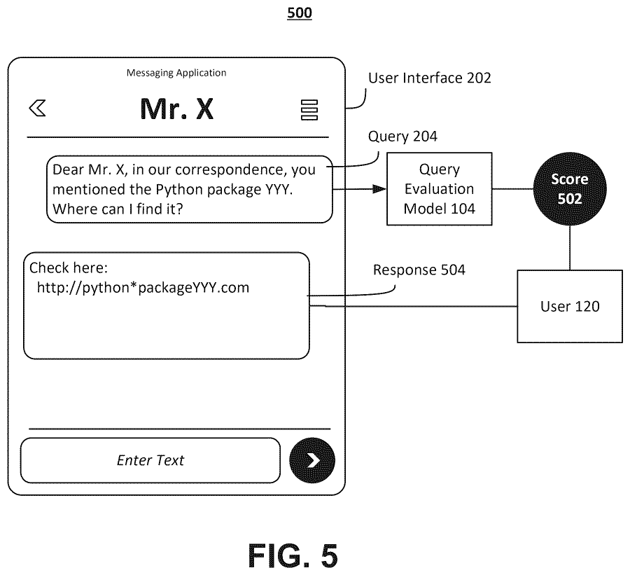

FIG. 5 is a diagram 500 illustrating a user interface with a response written by a user due to a low evaluation score of the input query. In diagram 500, suppose that query evaluation model 104 generates score 502, which is lower than the threshold query evaluation score. In this case, a response may not be generated using response generation model 106. Instead, query evaluation model 104 may request user 120 to provide response 504.

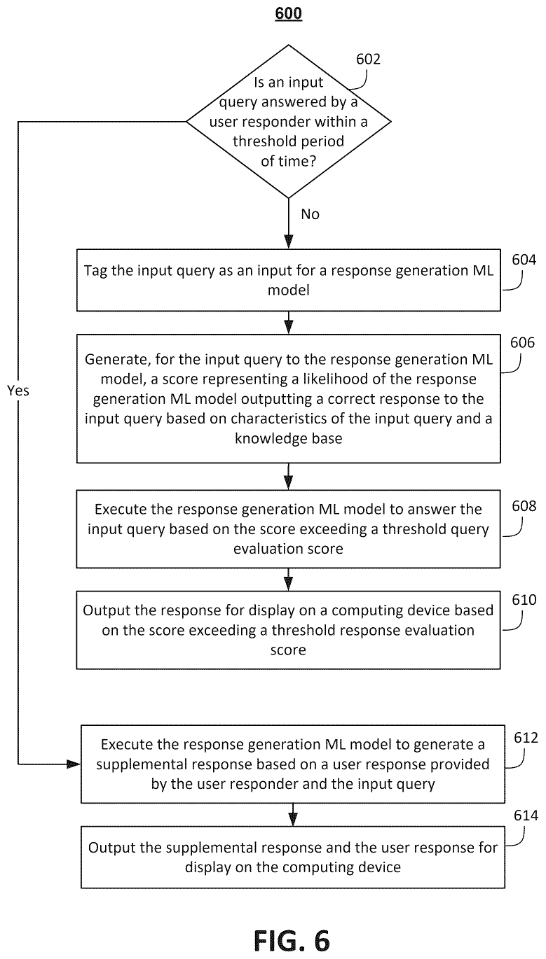

FIG. 6 illustrates a flow diagram of method 600 for generating evaluated responses to input queries using machine learning. At 602, evaluated response model 103 determines whether an input query (e.g., input query 102) is answered by a user responder within a threshold period of time. For example, the input query may originate from a student (a user requester) and the user responder may be a professor. The input query (e.g., a voice message, a text message, a video message, etc.) may be received via a user interface of a messaging application. For example, a student may send a text message or email to a professor.

In response to determining that the input query has not been answered within the threshold period of time, method 600 advances to 604, where evaluated response model 103 tags the input query as an input for a response generation ML model (e.g., model 106). At 606, evaluated response model 103 (specifically query evaluation model 104) generates, for the input query to the response generation ML model, a score (e.g., score 206) representing a likelihood of the response generation ML model outputting a correct response to the input query based on characteristics of the input query and a knowledge base (e.g., knowledge bases 110) comprising a plurality of documents and correspondence between the user responder (e.g., professor) and other user requesters (e.g., other students). For example, the correct response comprises an answer to the input query and/or clarifying questions pertaining to the input query.

In some aspects, the characteristics of the input query comprise one or more of: an amount of detail and a relevance to the knowledge base of the response generation ML model, and wherein the characteristics of the response comprise one or more of: correctness, completeness, and contextual alignment.

In some aspects, the score representing the likelihood of the response generation ML model outputting the correct response is generated by a query evaluation ML model in response to a score query. In some aspects, the response generation ML model and the query evaluation ML model are each a large language model.

At 608, evaluated response model 103 executes the response generation ML model to answer the input query based on the score exceeding a threshold query evaluation score.

At 610, evaluated response model 103 outputs the response (e.g., response 122) for display on a computing device based on the score exceeding a threshold response evaluation score.

In response to determining that the input query is answered by the user within the threshold period of time, method 600 advances to 612, where evaluated response model 103 executes the response generation ML model to generate a supplemental response based on a user response provided by the user responder and the input query. At 614, evaluated response model 103 outputs the supplemental response and the user response for display on the computing device.

In some aspects, the response is generated by the response generation ML model prior to determining that the input query is not answered by the user responder within the threshold period of time, and is outputted in response to determining that the input query is not answered by the user within the threshold period of time. For example, as soon as the input query is detected, the response generation ML model may generate the response, but may only output the response when the input query is not answered by the user responder within the threshold period of time.

In some aspects, evaluated response model 103 transmits the response to a different computing device (e.g., a laptop) of the user for verification. For example, if the user responder cannot be reached on his/her smartphone, evaluated response model 103 may attempt to send the response to the user on his/her laptop.

In some aspects, evaluated response model 103 may receive, from the different computing device, a modified version of the response as modified by the user responder. For example, the professor may make modifications to the response generated using evaluated response model 103. Evaluated response model 103 may then output the modified version of the response for display on the computing device.

In some aspects, the score is a first score and evaluated response model 103 may generate, for the response generated by the response generation ML model to the input query, a second score (e.g., score 404) representing a likelihood of the response being correct based on characteristics of the response. In some aspects, evaluated response model 103 may generate, by the response generation ML model, a new response to the input query based on the second score not exceeding the threshold response evaluation score. In some aspects, prior to generating the new response, evaluated response model 103 may modify the input query to improve the second score.

In some aspects, evaluated response model 103 may transmit an alert to a different computing device (e.g., a server where the response generation ML model is trained) based on a threshold number of responses generated by the response generation ML model for the input query failing to have scores that exceed the threshold response evaluation score.

In some aspects, evaluated response model 103 may generate statistics based on all interactions between the user responder, the response generation ML model, and the other user requesters.

In some aspects, evaluated response model 103 outputs, for display on the computing device, an indication that the response is generated using machine learning.

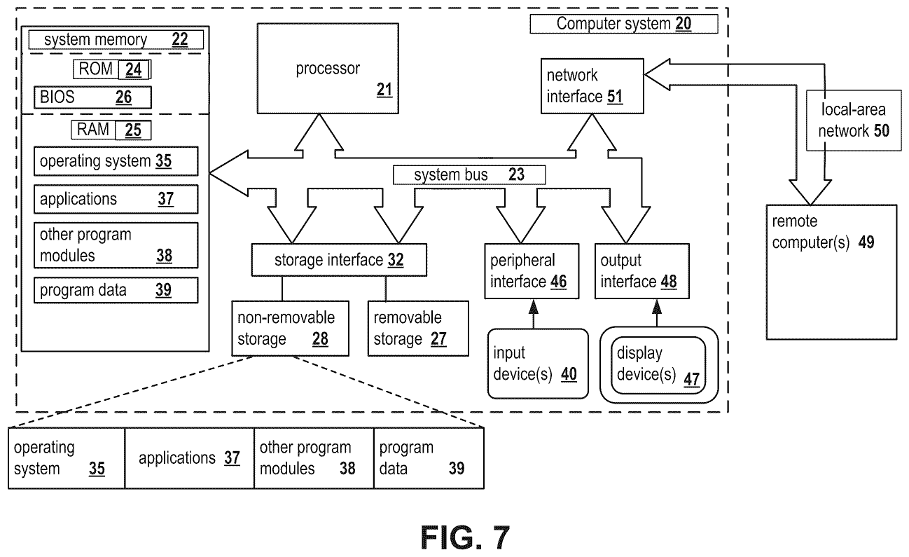

FIG. 7 is a block diagram illustrating a computer system 20 on which aspects of systems and methods for generating evaluated responses to input queries using machine learning may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating evaluated responses using machine learning (ML), the method comprising:
receiving an input query via a user interface;
in response to monitoring the user interface to determine that an input query is not answered by a user responder within a threshold period of time:
tagging the input query as an input for a response generation ML model;
generating, for the input query to the response generation ML model, a score representing a likelihood of the response generation ML model outputting a correct response to the input query based on characteristics of the input query and a knowledge base comprising a plurality of documents and a history of correspondence between the user responder and other user requesters;
executing the response generation ML model to answer the input query based on the score exceeding a threshold query evaluation score; and
outputting the response for display on a computing device based on the score exceeding a threshold response evaluation score; and
in response to monitoring the user interface to determine that the input query is answered by the user responder within the threshold period of time:
executing the response generation ML model to generate, using the user response provided by the user responder and the input query as inputs to the response generation ML model, a supplemental response supplementing the user response; and
outputting the supplemental response and the user response for display on the computing device.

2. The method of claim 1, wherein the correct response comprises an answer to the input query and/or clarifying questions pertaining to the input query.

3. The method of claim 1, wherein the response is generated by the response generation ML model prior to determining that the input query is not answered by the user responder within the threshold period of time, and is outputted in response to determining that the input query is not answered by the user responder within the threshold period of time.

4. The method of claim 1, wherein the score representing the likelihood of the response generation ML model outputting the correct response is generated by a query evaluation ML model in response to a score query.

5. The method of claim 4, wherein the response generation ML model and the query evaluation ML model are each a large language model.

6. The method of claim 1, wherein the characteristics of the input query comprise one or more of: an amount of detail and a relevance to the knowledge base of the response generation ML model, and wherein the characteristics of the response comprise one or more of:
correctness, completeness, and contextual alignment.

7. The method of claim 1, further comprising:
transmitting the response to a different computing device of the user responder for verification.

8. The method of claim 7, wherein the input query is provided by a student and received via a user interface, and wherein the user responder is an instructor of the student.

9. The method of claim 8, wherein the user interface is of a messaging application enabling communication between the student and the instructor.

10. The method of claim 7, further comprising:
receiving, from the different computing device, a modified version of the response as modified by the user responder; and
outputting the modified version of the response for display on the computing device.

11. The method of claim 1, wherein the score is a first score, further comprising:
generating, for the response generated by the response generation ML model to the input query, a second score representing a likelihood of the response being correct based on characteristics of the response; and
generating, by the response generation ML model, a new response to the input query based on the second score not exceeding the threshold response evaluation score.

12. The method of claim 11, further comprising:
transmitting an alert to a different computing device based on a threshold number of responses generated by the response generation ML model for the input query failing to have scores that exceed the threshold response evaluation score.

13. The method of claim 1, further comprising:
generating statistics based on all interactions between the user responder, the response generation ML model, and the other user requesters.

14. The method of claim 11, further comprising:
prior to generating the new response, modifying the input query to improve the second score.

15. The method of claim 1, further comprising:
outputting, for display on the computing device, an indication that the response is generated using machine learning.

16. A system for generating evaluated responses to input queries using machine learning, comprising:
at least one memory; and
at least one hardware processor coupled with the at least one memory and configured, individually or in combination, to:
receive an input query via a user interface;
in response to monitoring the user interface to determine that an input query is not answered by a user responder within a threshold period of time:
tag the input query as an input for a response generation ML model;
generate, for the input query to the response generation ML model, a score representing a likelihood of the response generation ML model outputting a correct response to the input query based on characteristics of the input query and a knowledge base comprising a plurality of documents and a history of correspondence between the user responder and other user requesters;
execute the response generation ML model to answer the input query based on the score exceeding a threshold query evaluation score; and
output the response for display on a computing device based on the score exceeding a threshold response evaluation score; and
in response to monitoring the user interface to determine that the input query is answered by the user responder within the threshold period of time:
execute the response generation ML model to generate, using the user response provided by the user responder and the input query as inputs to the response generation ML model, a supplemental response supplementing the user response; and
output the supplemental response and the user response for display on the computing device.

17. The system of claim 16, wherein the correct response comprises an answer to the input query and/or clarifying questions pertaining to the input query.

18. The system of claim 16, wherein the response is generated by the response generation ML model prior to determining that the input query is not answered by the user responder within the threshold period of time, and is outputted in response to determining that the input query is not answered by the user responder within the threshold period of time.

19. The system of claim 16, wherein the score representing the likelihood of the response generation ML model outputting the correct response is generated by a query evaluation ML model in response to a score query.

20. A non-transitory computer readable medium storing thereon computer executable instructions for generating evaluated responses to input queries using machine learning, including instructions for:
receiving an input query via a user interface;
in response to monitoring the user interface to determine that an input query is not answered by a user responder within a threshold period of time:
tagging the input query as an input for a response generation ML model;
generating, for the input query to the response generation ML model, a score representing a likelihood of the response generation ML model outputting a correct response to the input query based on characteristics of the input query and a knowledge base comprising a plurality of documents and a history of correspondence between the user responder and other user requesters;
executing the response generation ML model to answer the input query based on the score exceeding a threshold query evaluation score; and
outputting the response for display on a computing device based on the score exceeding a threshold response evaluation score; and
in response to monitoring the user interface to determine that the input query is answered by the user responder within the threshold period of time:
executing the response generation ML model to generate, using the user response provided by the user responder and the input query as inputs to the response generation ML model, a supplemental response supplementing the user response response; and
outputting the supplemental response and the user response for display on the computing device.
